(19) United States
(12) Patent Application Publication
(10) Pub. No.: US 2017/0147467 A1
(43) Pub. Date: May 25, 2017

(54) Method for Providing a Feedback Regarding Usage of an Application on a Portable Device by a User

(71) Applicant: Yu-Hsuan Lin, Taichung (TW)

(72) Inventor: Yu-Hsuan Lin, Taichung (TW)

(21) Appl. No.: 15/357,134

(22) Filed: Nov. 21, 2016

(30) Foreign Application Priority Data
Nov. 24, 2015 (TW) 104138883

(51) Int. Cl. G06F 11/34; G06F 11/30

(52) U.S. Cl. CPC G06F 11/3495; G06F 11/302; G06F 11/3013

(57) ABSTRACT

A method for evaluating usage of an application by a user on a portable device includes: obtaining an evaluation value regarding usage of the application within an evaluation period, the evaluation value being

associated with one of an accumulated number of times during the evaluation period, an accumulated usage duration during the evaluation period, and a median/average of multiple numbers of times of the usage at. respective time segments within the evaluation period; generating a comparison result; and based on the comparison result, outputting one of a positive feedback without interrupting execution of the application, and. a negative feedback to require user interaction with the portable device.

### CROSS-REFERENCE TO RELATED APPLICATION

This application claims priority of Taiwanese Patent Application No. 104138883, filed on Nov. 24, 2015.

### FIELD

The disclosure relates to a method for providing a feedback regarding usage of an application by a user on a portable device.

### BACKGROUND

Internet addiction refers to various kinds of excessive use of the Internet, which may result in interference with daily life. A survey conducted by the Ministry of Education of Taiwan shows that 20.40 percent of 4^{th} to 6^{th} graders are at high risk of developing Internet addiction, 23.70 percent of 7^{th} to 9^{th} graders are at high risk of developing Internet addiction, and 32.30 percent of 10^{th} to 12^{th} graders are at high risk of developing Internet addiction. Results of this survey suggest that approximately one out of five teenage students may probably develop Internet addiction.

Some psychologists and psychological clinicians think that treatment on a patient with Internet addiction may be more difficult than other addictive substances such as alcohol, tobacco and illicit drugs, as use of portable electronic devices with access to the Internet have been thoroughly integrated into our daily lives.

Current ways of determining whether a person is developing or has developed Internet addiction may involve recording usage of the electronic device. Taiwanese Patent Application No. 104117410 discloses one method for implementing such a determination.

### SUMMARY

Therefore, an object of the disclosure is to provide a method that can evaluate the usage of an application on a portable device by a user.

According to one embodiment of the disclosure, the method is for evaluating usage of an application by a user on a portable device. The portable device includes a processor for executing the application, the method is implemented by a calculating module and includes the following steps:

a) obtaining an evaluation value regarding usage of the application within an evaluation period, wherein the evaluation value is associated with one of: an accumulated number of times of the usage of the application during the evaluation period; an accumulated usage duration of the application by the processor during the evaluation period; a median of multiple numbers of times of the usage of the application at respective time segments within the evaluation period; and an average of the multiple numbers of times of the usage of the application at the respective time segments;

b) comparing the evaluation value with a threshold value, and generating a comparison result; and

c) based on the comparison. result, outputting one of a positive feedback without interrupting execution of the application, and a negative feedback to require user interaction with the portable device.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a portable device, according to one embodiment of the disclosure;

FIG. 2 is a flow chart illustrating steps of a method for providing a feedback regarding usage of an application on the portable device by the user, according to one embodiment of the disclosure;

FIG. 3 illustrates a set of reference parameters and an evaluation value that is obtained within an evaluation period of one month and that is associated. with the usage of an application on the portable device by the user;

FIG. 4 illustrates a set of reference parameters and evaluation values that are obtained within evaluation periods of one day in length and that are associated with the usage of an application on the portable device by the user;

FIG. 5 illustrates multiple sets of reference parameters associated with multiple persons, according to one embodiment of the disclosure;

FIG. 6 illustrates an evaluation value that is associated with the usage of an application on the portable device and that is used in the method with reference to the reference parameters shown in FIG. 5; and

FIG. 7 illustrates a system for performing the method, according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

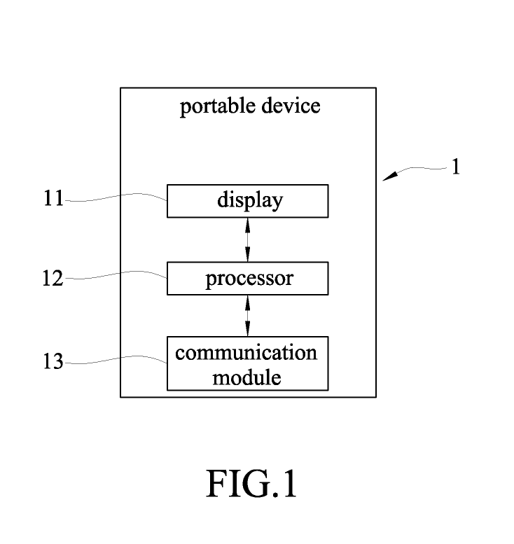

FIG. 1 illustrates a portable device 1 that includes a display 11, processor 12 and a communication module 13, according to one embodiment of the disclosure.

The portable device 1 may be embodied using, for example, a smart phone, a tablet computer or a wearable electronic device, and equipped with communication functionality. In this embodiment, the portable device 1 is a smart phone with communication functionality.

The processor 12 executes one or more applications based on commands from a user. The application may include, for example, an instant messaging application.

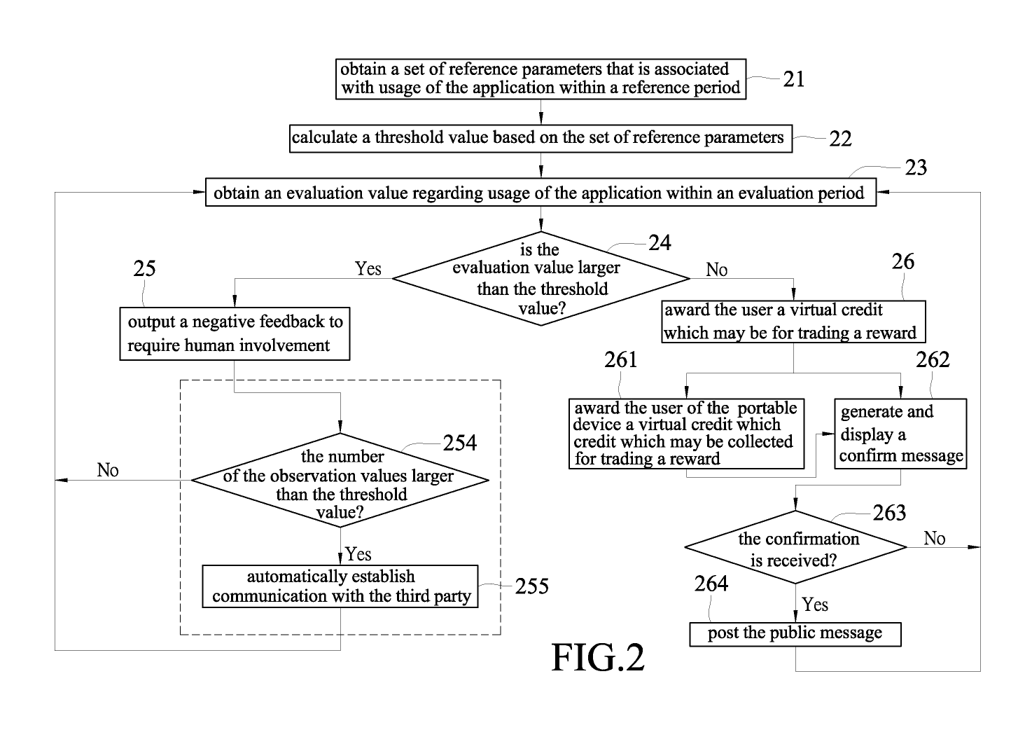

FIG. 2 is a flowchart illustrating steps of a method for providing a feedback regarding usage of an application on the portable device 1 by the user, according to one embodiment of the disclosure. Specifically, usage of an application on the portable device 1 may imply the user using the portable device 1, and overuse of the application implies excessive use of the portable device 1 by the user, and may further imply that the user may have developed Internet addition.

In this embodiment, the processor 12, executing an evaluating application program, serves as a calculating module for implementing the method. That is to say, the calculating module is integrated into the portable device 1.

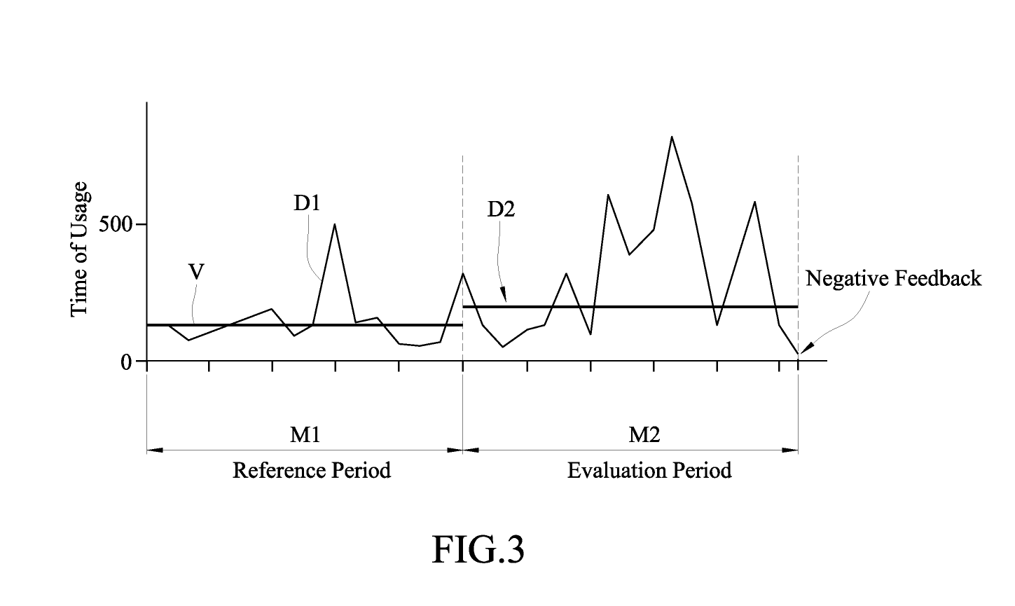

In step 21, the processor 12 obtains a set of reference parameters (D1) that is associated with usage of an application within a reference period (M1) (see FIG. 3). The reference period (M1) maybe one spanning at least one day, such as one day, one week, one month, etc.

In this embodiment, the reference parameters of the set associated with usage of the application by the user are obtained at respective time segments during the reference period (M1) (e.g., each day or specific times of the day).

The application may be one associated with social interactions (e.g., Facebook, Line, Wechat, etc.) gaming (e.g., Candy Crush, Tower of Saviors, etc.), or productivity (e.g., Microsoft Outlook, Pages, Microsoft Word, etc.). In some embodiments, the user may select a specific one or a specific type of the applications installed in the portable device 1 to have the usage thereof monitored using the method of FIG. 2.

The set of reference parameters (D1) may be associated with certain statistics regarding the use of the application. For example, the certain statistics may include one of an accumulated number of times of the usage of the application during the reference period (M1), an accumulated usage duration of the application during the reference period (M1) (i.e., usage duration accumulated every time the application is executed by the processor 12 during the reference period (M1)), a median of multiple numbers of times of the usage of the application at respective time segments within the reference period (M1), and an average of the multiple numbers of times of the usage of the application at the respective time segments of the reference period (M1).

In some embodiments, the set of reference parameters (D1) may be obtained using a method as described in U.S. patent application Ser. No. 15/163262.

In step 22, the processor 12 calculates a threshold value (V) based on the set of reference parameters (D1). For example, when the reference period (M1) spans one month and includes 30 time segments (each spanning one day), the set of reference parameters (D1) may include 30 values each being associated with certain statistics regarding execution of the application in a respective one of the time segments (e.g., accumulated usage duration during the day, accumulated number of times of the usage during the day, etc.). In such cases, calculation of the threshold value (V) may involve calculating an average or finding a median of the 30 values. In other embodiments, a specific percentile of the set of reference parameters (D1) may be set as the threshold value (V). For example, the specific percentile may be between the 25^{th} and 75^{th} percentiles of the set of reference parameters (D1).

In step 23, the processor 12 obtains an evaluation value (D2) regarding usage of the application within an evaluation period (M2).

The evaluation value (D2) is associated with one of an accumulated number of times of the usage of the application during the evaluation period (M2), an accumulated usage duration of the application by the processor 12 during the evaluation period (M2), a median of multiple numbers of times of the usage of the application at respective time segments within the evaluation period (M2), and an average of the multiple numbers of times of the usage of the application at the respective time segments of the evaluation period (M2) In the example shown. in FIG. 3, the reference period (M1) is earlier than the evaluation period (M2). The processor 12 may collect data regarding usage of the application by the user for multiple months, where the first month serves as the reference period (M1) and each of the second month and subsequent month (s) serves as an evaluation period (M2).

In step 24, the processor 12 compares the evaluation value (D2) with the threshold value (V), and generates a comparison result. Based on the comparison result, the processor 12 is capable of determining whether or not the evaluation value (D2) is larger than the threshold value (V). When the evaluation value (D2) is larger than the threshold value (V), it means that the user may have used the application more frequently in the evaluation period (M2) than in the reference period (M1), and as a result, the flow proceeds to step 25. Otherwise, the flow proceeds to step 26.

In step 25, the processor 12 outputs a negative feedback to require human involvement.

In one example, after the portable device 1 is installed with a gaming application, the evaluating application program may be executed to obtain statistics regarding the usage of the gaming application during the first month, which serves as the reference period (M). By the end of the reference period (M1), the processor 12 would have obtained the set of reference parameters (D1) including, e.g., 30 entries of accumulated usage time each associated with a respective day.

Afterward, the processor 12 calculates an average of the set of reference parameters (D1) (which may be, for example, one hour per day), and sets the average as the threshold value (V). Then, in the following days, where each day serves as the evaluation period (M2), the processor 12 keeps track of an accumulated usage time associated with the gaming application for each day. In the case the accumulated usage time for particular evaluation period (M2) (i.e., a particular day) is determined to be longer than one hour (e.g., 4 hours), the processor 12 proceeds to generate the negative feedback in step 25.

In some embodiments, the processor 12 outputs the negative feedback by sending an alert output. to the portable device 1 for notifying the user. The alert output may include one or more of a push message, a text message, an audible ring, a vibration and a flashing light. For example, the alert output may include one or more of a push message and a text message that are displayed on the display 11 of the portable device 1 and that include warning text for warning the user. Information regarding a third party may be included in the push message and/or the text message. The third party may include one or more of a family member, a friend, a teacher, a supervisor and a therapist of the user. The information may include one or more of an address, a map with navigation toward the address, a website and a telephone number of the third party. In response to the information regarding the third party, the user of the portable device 1 may decide whether to establish a communication with the third party. When it is decided by the user to establish a communication with the third party, the processor 12 may control the portable device 1 to initiate a telephone call or to transmit a message via an instant messaging application.

In some embodiments, the processor 12 outputs the negative feedback by executing a sequence in an attempt to cause the user to reduce use of the application. For example, when it is determined that the gaming application has been executed for longer than one hour in one day, the processor 12 may proceed to generate one or more push alerts to be displayed on the display 11 while the gaming application is being executed (i.e., without interrupting execution of the gaming application), thereby distracting and interrupting the user. In response, the user is required to interact with the push alert (e.g., manually touch the display 11) in order to close the push alert.

In some embodiments, the processor 12 outputs the negative feedback by posting a public message on a public platform. The public message includes information regarding the user and the usage of the application. The public platform includes one or more of a social network site, a customized group of email addresses, and a social networking application. The social network site includes one or more of Facebook, Twitter and Instagram, and the social networking application includes one or more of Whatsapp, Line and Wechat.

In the example shown in FIG. 3, the evaluation value (D2) is obtained. by the processor 12 in step 22 regarding the usage of the application throughout the evaluation period (M2), and step 24 is executed to compare the evaluation value (D2) with the threshold value (V) to determine whether or not the evaluation value (D2) is greater than the threshold value (V) when the entire evaluation period (M2) has elapsed. In such a case, the negative feedback is outputted after the entire evaluation period (M2) has elapsed.

In one example, the accumulated number of times of the usage of the application obtained in the reference period. (M1) is 500 times, and an average of the accumulated number of times, which is calculated as 500/30=16.7, is set as the threshold value (V). In another example, the 75^{th} percentile of the multiple numbers of times (e.g., 25) at the respective time segments within the reference period (M1) may be used as the threshold value (V). It should be noted that a unit time with respect to which the threshold value (V) is defined must be the same as a unit time with respect to which the evaluation value (D2) is defined. In the above example, the time unit of the threshold value (V) is one day, and the time unit of the evaluation value (D2) must also be one day. Therefore, the evaluation value (D2) can be the accumulated number of times of the usage of the application during one day (i.e., the evaluation period (M2) is one day), or the median or average of the multiple numbers of times of the usage of the application at respective days within one month (i.e., the evaluation period (M2) is one month).

When it is determined that the average or the median of the multiple numbers of times collected in one month of the evaluation period (M2) is larger than 16.7 or 25, at the end of the month of the evaluation period (M2) the processor 12 may start generating the negative feedback (see FIG. 3).

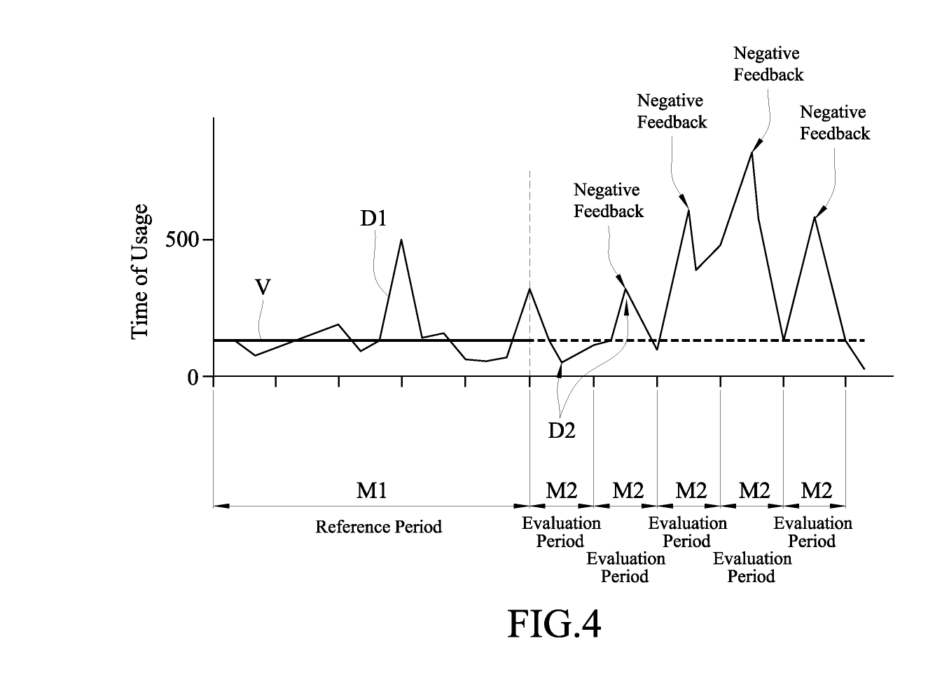

Alternatively, in some embodiments, when the accumulated number of times of the usage of the application in one day is larger than 16.7 or 25, the processor 12 may generate the negative feedback at the end of the day (see FIG. 4). That is to say, for each day the processor 12 determines whether the accumulated number of times is larger than 16.7 or 25.

In another embodiment, the processor 12 is programmed to continuously compute the evaluation value (D2) during the evaluation period (M2), and compare the evaluation value (D2) obtained with the threshold value and to output the negative feedback whenever the evaluation value (D2) is determined to be greater than the threshold value (V) during/within the evaluation period (12). For example, when the threshold value (V) is set at 16.7, the processor 12 may start outputting the negative feedback. when a 17^{th} time of usage of the gaming application is detected during one day even though the evaluation period (M2) has not elapsed yet.

In step 254, the processor 12 obtains a plurality of observation values (D3) regarding usage of the application within an observation period (M3) following the evaluation period (M2). In one embodiment, the observation period (M3) has a length that is a multiple of the evaluation period (M2). For example, in the case that the evaluation period (M2) is one month long, the observation period (M3) may be three months long, and the processor 12 obtains three observation values (D3) each corresponding with one respective month of the observation period (M3)

Afterward, the processor 12 compares each of the observation values (D3) with the threshold value (V). When it is determined that all of the observation values (D3) are individually larger than the threshold value (V) , the flow proceeds to step 255. Otherwise, the flow goes back to step 23.

In this example, the determination that all of the observation values (D3) are individually larger than the threshold value (V) indicates that the user has continued to use the gaming application for more than one hour per day for three straight months. As a result, in step 255, the processor 12 automatically establishes the communication with the third party.

When the processor 12 determines that the evaluation value (D2) is not larger than the threshold value (V), the processor 12 generates the positive feedback in step 26.

Specifically, step 26 may include the following sub-steps.

In sub-step 261, the processor 12 awards the user of the portable device 1 a virtual credit which may be collected for trading a reward. Specifically, the processor 12 may deposit the virtual credit in a personal virtual account that is associated with the user of the portable device 1.

In sub-step 262, the processor 12 generates and. displays a confirm message directing the user to determine whether to proceed to post a public message on a public platform.

When the user decides to allow the portable device 1 to post the public message, he/she may operate the portable device 1 to input a confirmation indicating that the user agrees to proceed to post the public message.

In sub-step 263, the processor 12 determines whether the confirmation is received. When the confirmation is received, the flow proceeds to sub-step 264. Otherwise, the flow goes back to step 23.

In sub-step 264, the processor 12 controls the portable device 1 to post the public message.

In this embodiment, the public message includes one or more of a push message, a text message, and a post on a social network site. The public message includes information regarding the user and the usage of the application. The information regarding the usage of the application may be represented in a graph. The portable device 1 communicates with the public platform via one of a wireless network, a wireless sensor network and a cellular network. The public platform includes one or more of a social network site, a customized group of email addresses, and a social networking application. The social network site includes one or more of Facebook, Twitter and Instagram, and the social networking application includes one or more of Whatsapp, Line and Wechat. In this way, the information regarding usage of the application by the user may be conveyed to a third party.

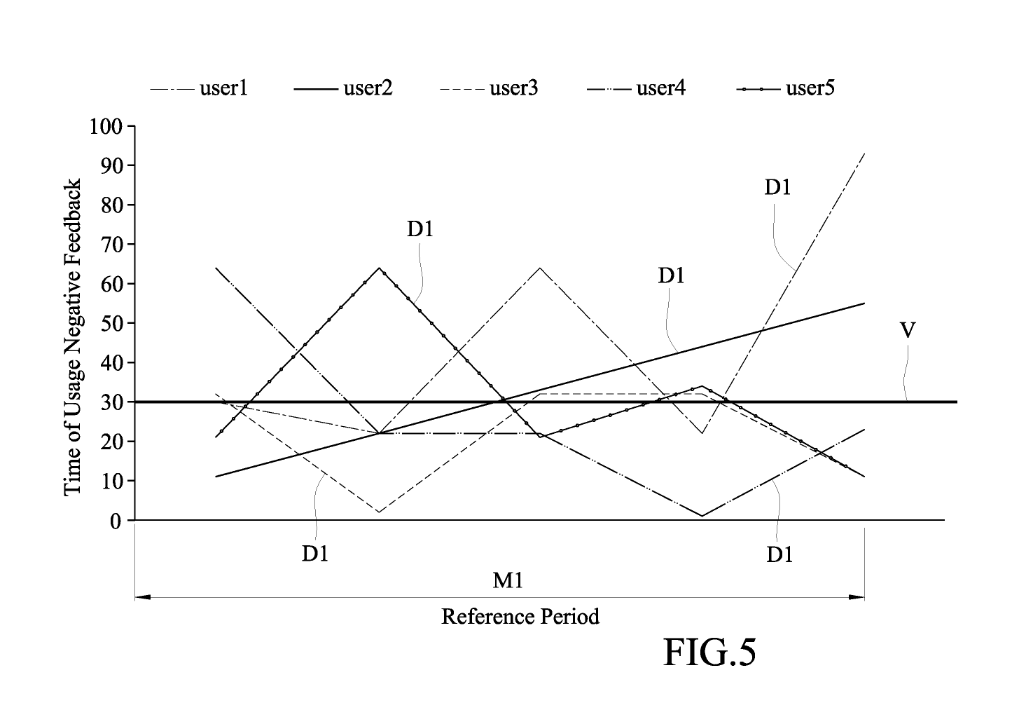

In one embodiment as depicted in FIG. 5, five sets of reference parameters (D1) may be obtained, and are associated with usage of the application respectively by multiple persons in a group of people (five people in this embodiment), which may exclude the user, during a reference period (M1) prior to the evaluation period (M2).

Specifically, each set of reference parameters (D1) is associated with one person in the group, and each reference parameter in the set indicates a daily number of times of usage of the application by the person during the reference period (M1). In calculating the threshold value (V), the processor 12 may calculate an average of the sets of reference parameters (D1), and set the calculated average as the threshold value (V). Alternatively, the processor 12 may determine a specific percentile of the set of reference parameters (D1), and set the specific percentile as the threshold value (V).

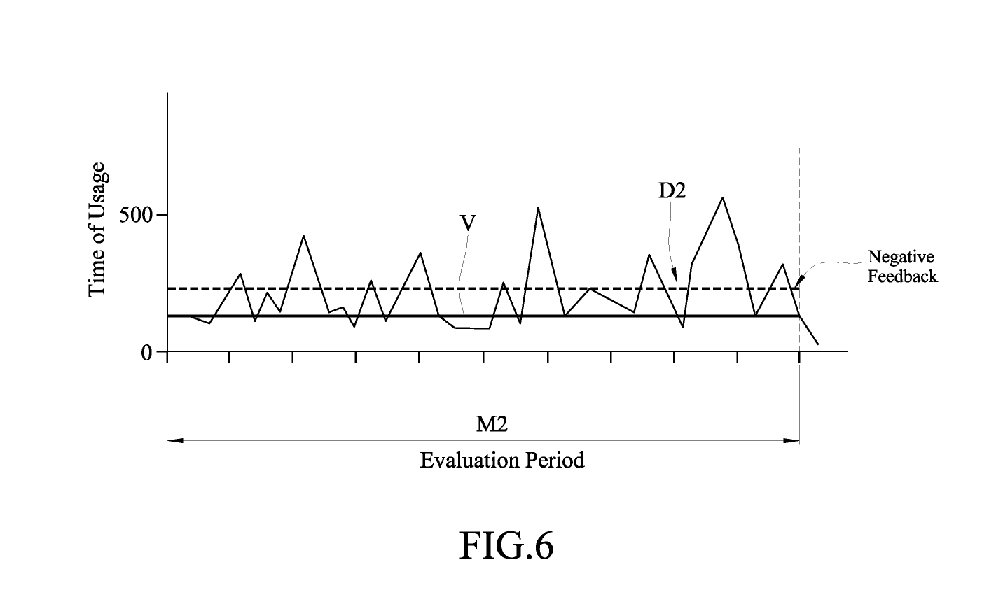

Afterward, in step 23, the processor 12 obtains the evaluation value (D2) regarding usage of the application within the evaluation period (M2) by the user (see FIG. 6). It is noted that in this embodiment, the processor 12 does not need to additionally spend the reference period (M1) in order to obtain the threshold value (V), and instead, as soon as the monitoring of the activities of the application starts, the processor 12 may start evaluating the usage on, e.g., a daily basis with each day being the evaluation period (M2).

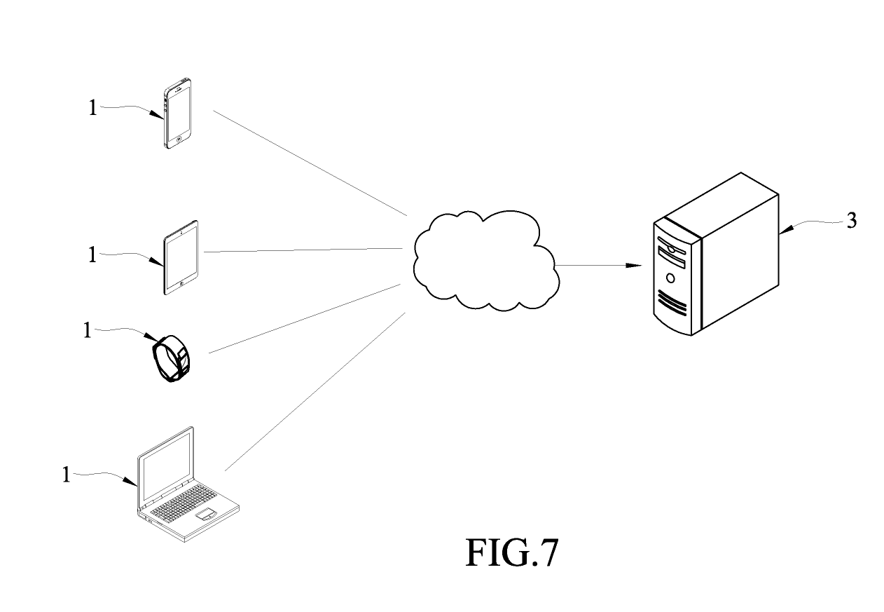

In one embodiment, the portable device 1 is configured to communicate with a server host 3 (see FIG. 7) for transmitting the evaluation value (D2) and the comparison result thereto. As such, the server host 3 is able to collect the data regarding the user, which may be later used for evaluating another user (i.e., as part of the group of people).

FIG. 7 illustrates a system according to one embodiment of the disclosure. In this embodiment, the calculating module is included in the server host 3 that communicates with the portable device 1 via the communication module 13 (see FIG. 1).

In this embodiment, the evaluation value (D2) is obtained by the processor 12 (see FIG. 1), and is transmitted to the server host 3. The reference parameters may be obtained by one of the processor 12 and the server host 3, depending on whether the reference parameters are associated with the user or the group of people.

Afterward, the comparing result is generated by the server host 3, and is transmitted back to the portable device 1 such that the portable device 1 may output a corresponding one of the positive and negative feedback according to the comparing result from the server host 3.

To sum up, the method as described by embodiments of the disclosure provides a unique mechanism for discouraging the user to excessively use an application, instead of directly and entirely forbidding use of the application. As a result, the method may aid the user in improving his/her time management.

Additionally, the method allows the portable device 1 to automatically establish a communication with the server host 3 and/or the third party who may be a family member, a friend, a teacher, a supervisor and a therapist of the user. As such, the method enables the third party to be informed with the usage of the application by the user, and allows the user to seek help from other people via the portable device 1 when it is determined that the user is over-using the application.

For example, when a family member of the user (e.g., a parent), a number of classmates and/or a teacher of the user is/are informed of the usage, a group therapy may be conducted in order to discourage the user from over-using the application. A therapist may use the associated data to perform a treatment. A work supervisor of the user may be able to find out working efficiency of the user.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification. to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiments but is intended to cover various arrangements included within. the spirit and scope of the broadest interpretation so as to encompass all such modifications and equivalent arrangements.

What is claimed is:

1. A method for evaluating usage of an application by a user on a portable device, the portable device including a processor for executing the application, the method being implemented by a calculating module and comprising steps of:
a) obtaining an evaluation value regarding usage of the application within an evaluation period, wherein the evaluation value is associated with one of: an accumulated number of times of the usage of the application during the evaluation period; an accumulated usage duration of the application by the processor during the evaluation period; a median of multiple numbers of times of the usage of the application at respective time segments within the evaluation period; and an average of the multiple numbers of times of the usage of the application at the respective time segments;
b) comparing the evaluation value with a threshold value, and generating a comparison result; and
c) based on the comparison. result, outputting one of a positive feedback without interrupting execution of the application, and a negative feedback to require human involvement.

2. The method of claim 1, wherein step a) includes obtaining, from the processor of the portable device, information regarding the usage of the application within the evaluation period, and calculating the evaluation value based on the information obtained from the processor.

3. The method of claim 2, wherein a length of the evaluation period is one of one day, one week and one month.

4. The method of claim 1, wherein the evaluation value obtained in step a) is associated with the usage of the application throughout the evaluation period, step b) is to compare the evaluation value with the threshold value to determine whether the evaluation value is greater than the threshold value when the evaluation period has elapsed, and step c) is to output the negative feedback when the evaluation value is greater than the threshold value.

5. The method of claim 4, wherein a length of the evaluation period is one of one day, one week and one month.

6. The method of claim 1, further comprising, prior to step b), steps of:
obtaining a set of reference parameters associated. with usage of the application by the user at respective time segments during a reference period prior to the evaluation period; and
calculating an average of the set of reference parameters, and setting the average of the set of reference parameters as the threshold value.

7. The method of claim 6, wherein a length of the reference period is one of one day, one week or one month.

8. The method of claim 1, further comprising, prior to step b), the steps of:
obtaining a set of reference parameters associated with usage of the application by the user at respective time segments during a reference period prior to the evaluation period; and
determining a specific percentile of the set of reference parameters, and setting the specific percentile as the threshold value.

9. The method of claim 8, wherein the specific percentile is between the 25^{th} and 75^{th} percentiles.

10. The method of claim 8, wherein a length of the reference period is one of one day, one week or one month.

11. The method of claim 1, further comprising, prior to step b), steps of:
obtaining multiple sets of reference parameters associated with usage of the application respectively by multiple persons during a reference period prior to the evaluation period; and
calculating an average of the sets of reference parameters, and setting the average as the threshold value.

12. The method of claim 11, wherein a length of the reference period is one of one day, one week or one month.

13. The method of claim 1, further comprising, prior to step b), steps of:
obtaining multiple sets of reference parameters associated with usage of the application respectively by multiple persons during a reference period prior to the evaluation period; and
determining a specific percentile of the set of reference parameters, and setting the specific percentile as the threshold value.

14. The method of claim 13, wherein the specific percentile is between the 25^{th} and 75^{th} percentiles.

15. The method of claim 13, wherein a length of the reference period is one of one day, one week or one month.

16. The method of claim 1, wherein the negative feedback includes sending an alert output to the portable device for notifying the user.

17. The method of claim 16, wherein the alert output includes one or more of a push message, a text message, an audible ring, a vibration and a flashing light.

18. The method of claim 16, wherein the alert output includes one or more of a push message and a text message that are displayed on a display of the portable device and that include warning text for warning the user.

19. The method of claim 18, wherein the alert output includes information regarding a third party, the information including one or more of an address, a map with navigation toward the address, a website and a telephone number.

20. The method of claim 19, wherein the third party includes one or more of a family member, a friend, a teacher, a supervisor and a therapist of the user.

21. The method of claim 1, wherein the negative feedback includes controlling the portable device to execute a sequence in an attempt to cause the user to reduce use of the application.

22. The method of claim 1, wherein the negative feedback includes controlling the portable device to establish a communication with a third party.

23. The method of claim 22, wherein the communication is established by one of a telephone call and an instant messaging application.

24. The method of claim 22, wherein the third party includes one or more of a family member, a friend, a teacher, a supervisor and a therapist of the user.

25. The method of claim 1, wherein the negative feedback includes posting a public message on a public platform, the public message including information regarding the user and the usage of the application.

26. The method of claim 25, wherein the public platform includes one or more of a social network site, a customized group of email addresses, and a social networking application.

27. The method of claim 25, wherein the portable device communicates with the public platform via one of a wireless network, a wireless sensor network and a cellular network.

28. The method of claim 25, wherein the public message includes one or more of a push message, a text message, and a post on a social network site.

29. The method claim 25, wherein the information regarding the usage of the application is represented in a graph.

30. The method of claim 1, wherein the positive feedback includes awarding the user of the portable device with a virtual credit which may be collected for trading a reward.

31. The method of claim 1, wherein the positive feedback includes posting a public message on a public platform, the public message including information regarding the user and the usage of the application.

32. The method of claim 31, wherein the public platform. includes one or more of a social network site, a customized group of email addresses, and a social networking application.

33. The method of claim 32, wherein: the social network site includes one or more of Facebook, Twitter and Instagram, and the social networking application includes one or more of Whatsapp, Line and Wechat.

34. The method of claim 31, wherein posting a public message on a public platform includes:
controlling the portable device to display a confirm message to the user, the confirm message directing the user to determine whether to proceed to post the public message; and
when a confirmation indicating that the user agrees to proceed is received, controlling the portable device to post the public message.

35. The method of claim 31, wherein the portable device communicates with the public platform via one of a wireless network, a wireless sensor network and a cellular network.

36. The method of claim 31, wherein the public message includes one or more of a push message, a text message, and a post on a social network site.

37. The method of claim 31, wherein the information regarding the usage of the application is represented in a graph.

38. The method of claim 1, wherein the application is selected from one of a social networking application, a gaming application and a commercial application.

39. The method of claim 1, wherein the portable device is one of a smartphone, a tablet computer and a wearable device that has communication functionality.

40. The method of claim 1, wherein the calculating module is included in a server host that communicates with the portable device.

41. The method of claim 1, wherein the calculating module is integrated into the portable device.

42. The method of claim 41, further comprising a step of communicating with a server host for transmitting the evaluation value and the comparison result thereto.
